(19) United States
(12) Patent Application Publication
(10) Pub. No.: US 2025/0018490 A1
(43) Pub. Date: Jan. 16, 2025

(54) Hot Press Welding Head, Wire Welding Device and Method

(71) Applicants: TE Connectivity Solutions GmbH, Schaffhausen (CH); Tyco Electronics (Shanghai) Co., Ltd., Shanghai (CN)

(72) Inventors: Zongjie (Jason) Tao, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 18/766,824

(22) Filed: Jul. 9, 2024

(30) Foreign Application Priority Data
Jul. 10, 2023 (CN) 202310843277.X

(51) Int. Cl. B23K 3/03; B23K 11/00

(52) U.S. Cl. CPC B23K 3/0376; B23K 11/0026

(57) ABSTRACT

A hot press welding head includes a main body having a front side surface and a rear side surface opposite to each other in its transverse direction, and a curved bottom surface between bottom edges of the front side surface and the rear side surface. The bottom edge of the front side surface is lower than the bottom edge of the rear side surface in a height direction of the main body. Multiple positioning slots are formed on the curved bottom surface. The multiple positioning slots are arranged in a row along a longitudinal direction of the main body for simultaneously positioning multiple welded wires. The positioning slot extends along the transverse direction of the main body between the front side surface and the rear side surface.

### CROSS-REFERENCE TO RELATED APPLICATION

This application claims the benefit of Chinese Patent Application No. CN202310843277.X filed on Jul. 10, 2023, in the State Intellectual Property Office of China, the whole disclosure of which is incorporated herein by reference.

### FIELD OF THE INVENTION

Embodiments of the present disclosure relate to a hot press welding head, a wire welding device comprising the hot press welding head as well as a method for welding wires using the wire welding device.

### BACKGROUND

In the prior art, a hot press welding head can only weld a single wire, resulting in low welding efficiency. In addition, in the prior art, manual alignment of the hot press welding head and the wire is required, which is time-consuming and laborious, further reducing welding efficiency.

### SUMMARY

According to an embodiment of the present disclosure, a hot press welding head includes a main body having a front side surface and a rear side surface opposite to each other in its transverse direction, and a curved bottom surface between bottom edges of the front side surface and the rear side surface. The bottom edge of the front side surface is lower than the bottom edge of the rear side surface in a height direction of the main body. Multiple positioning slots are formed on the curved bottom surface. The multiple positioning slots are arranged in a row along a longitudinal direction of the main body for simultaneously positioning multiple welded wires. The positioning slot extends along the transverse direction of the main body between the front side surface and the rear side surface.

### BRIEF DESCRIPTION OF THE DRAWINGS

The invention will now be described by way of example with reference to the accompanying Figures, of which:

FIG. 1 shows an illustrative perspective view of a hot press welding head according to an exemplary embodiment of the present invention;

FIG. 2 shows an illustrative perspective view of the main body of a hot press welding head according to an exemplary embodiment of the present invention;

FIG. 3A shows an illustrative local enlarged view of the main body of a hot press welding head according to an exemplary embodiment of the present invention;

FIG. 3B shows an illustrative local enlarged plan view of the main body of a hot press welding head according to an exemplary embodiment of the present invention;

FIG. 4A shows an illustrative view of aligning the positioning slot on the hot press welding head with the wire;

FIG. 4B shows an illustrative view of positioning the wire in the front part of the positioning slot of the hot press welding head by vertically moving the hot press welding head;

FIG. 4C shows an illustrative view of positioning the wire in the front part and middle part of the positioning slot of the hot press welding head by rotating the hot press welding head;

FIG. 4D shows an illustrative view of moving the hot press welding head horizontally to the end to be welded of the wire;

FIG. 4E shows an illustrative view of positioning the wire in the front part, middle part, and rear part of the positioning slot of the hot press welding head by rotating the hot press welding head;

FIG. 5A shows an illustrative view of a row of wires positioned in the positioning slot of the hot press welding head, wherein the hot press welding head is in its initial position near the fixed end of the row of wires;

FIG. 5B shows an illustrative view of the hot press welding head being horizontally moved to the ends to be welded of a row of wires; and

FIG. 6 shows an illustrative view of a row of wires positioned in a row of positioning slots of the hot press welding head.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to one embodiment of the present disclosure, a hot press welding head comprises a main body having a front side surface and a rear side surface opposite to each other in its transverse direction, as well as a curved bottom surface between bottom edges of the front side surface and the rear side surface. The bottom edge of the front side surface is lower than the bottom edge of the rear side surface in a height direction of the main body. Multiple positioning slots are formed on the curved bottom surface. The multiple positioning slots are arranged in a row along a longitudinal direction of the main body for simultaneously positioning multiple welded wires. The positioning slot extends along the transverse direction of the main body between the front side surface and the rear side surface.

According to another embodiment, a wire welding device comprises the above hot press welding head, and a moving device adapted to move the hot press welding head to position a row of wires into the row of positioning slots of the hot press welding head.

According to another embodiment, a wire welding method comprising the steps of: 1) providing the above hot press welding head or the above wire welding device; 2) moving the hot press welding head so that the row of positioning slots on the hot press welding head are aligned with a row of wires to be welded; and 3) moving the hot press welding head so that the row of wires is positioned in the row of positioning slots of the hot press welding head.

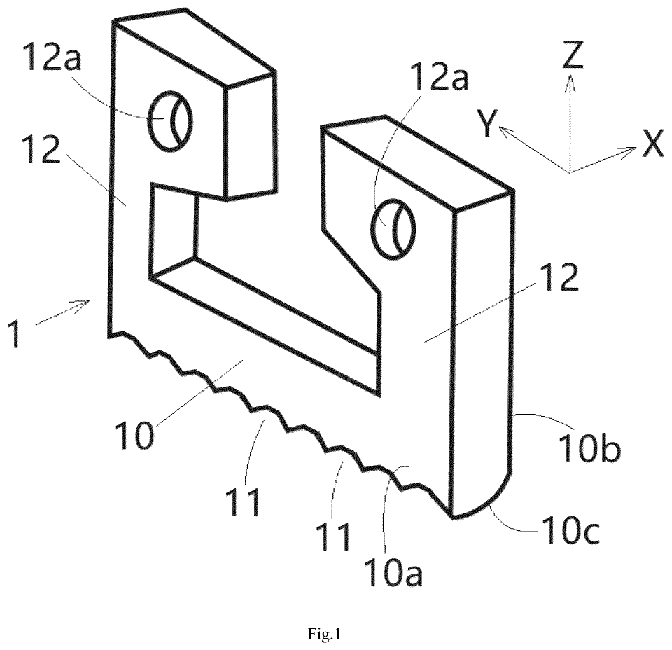

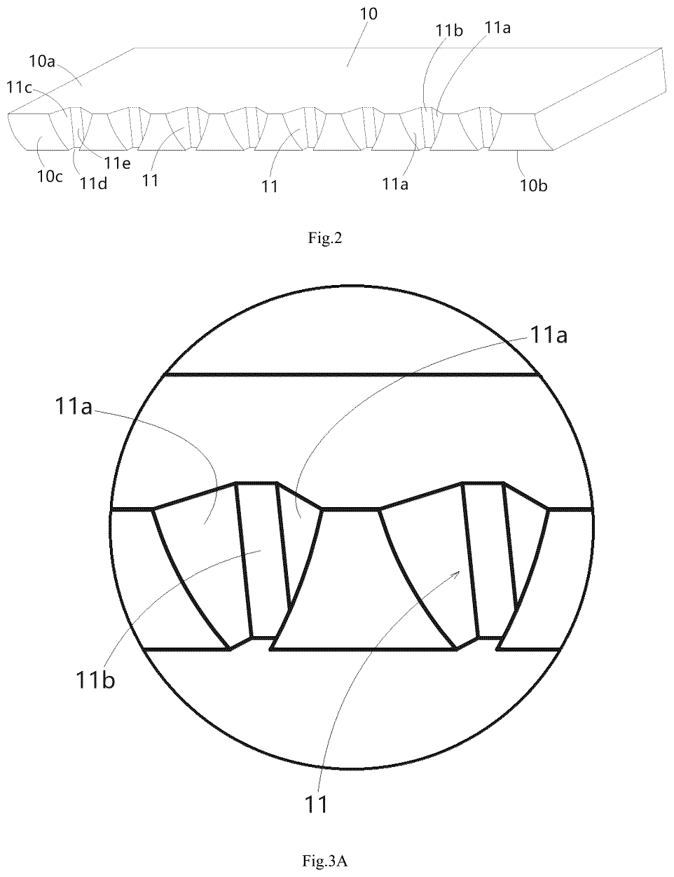

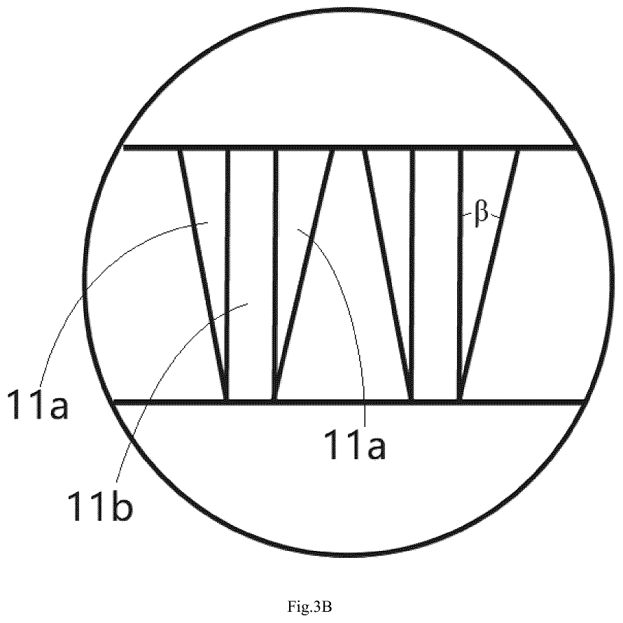

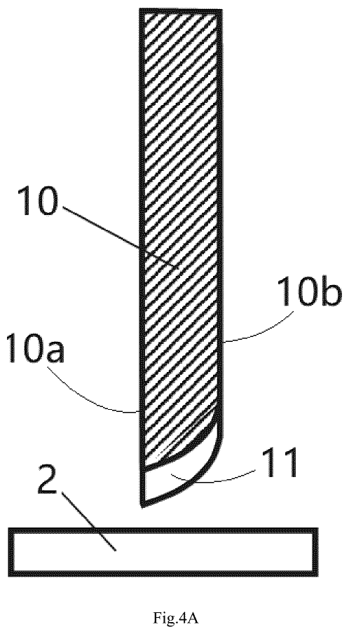

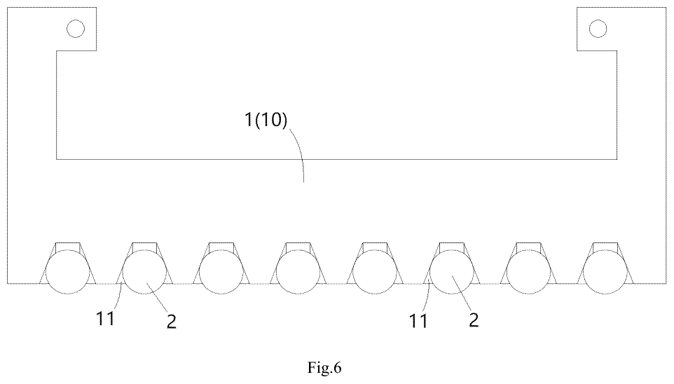

FIG. 1 shows an illustrative perspective view of a hot press welding head 1 according to an exemplary embodiment of the present invention. FIG. 2 shows an illustrative perspective view of the main body 10 of the hot press welding head 1 according to an exemplary embodiment of the present invention. FIG. 3A shows an illustrative local enlarged view of the main body 10 of the hot press welding head 1 according to an exemplary embodiment of the present invention. FIG. 3B shows an illustrative local enlarged plan view of the main body 10 of the hot press welding head 1 according to an exemplary embodiment of the present invention. FIG. 6 shows an illustrative view of a row of wires 2 positioned in a row of positioning slots 11 of the hot press welding head 1.

As shown in FIGS. 1-3 and 6, in an exemplary embodiment of the present disclosure, a hot press welding head 1 includes a main body 10. The main body 10 has a front side surface 10a and a rear side surface 10b opposite to each other on its transverse direction X, as well as a curved bottom surface 10c between bottom edges of the front side surface 10a and the rear side surface 10b. The bottom edge of the front side surface 10a of the main body 10 is lower than the bottom edge of the rear side surface 10b of the main body 10 in a height direction Z of the main body 10. Multiple positioning slots 11 are formed on the curved bottom surface 10c of the main body 10. The multiple positioning slots 11 are arranged in a row along the longitudinal direction Y of the main body 10 for simultaneously positioning multiple welded wires 2. In the illustrated embodiment, the positioning slot 11 extends between the front side surface 10a and the rear side surface 10b along the transverse direction X of the main body 10.

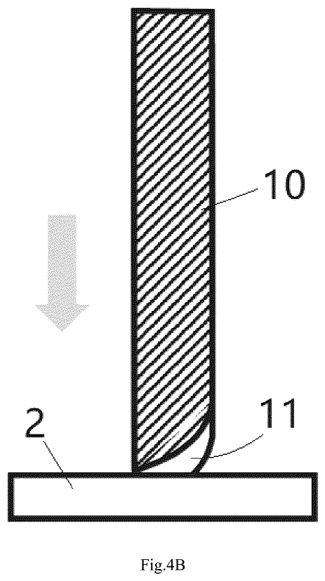

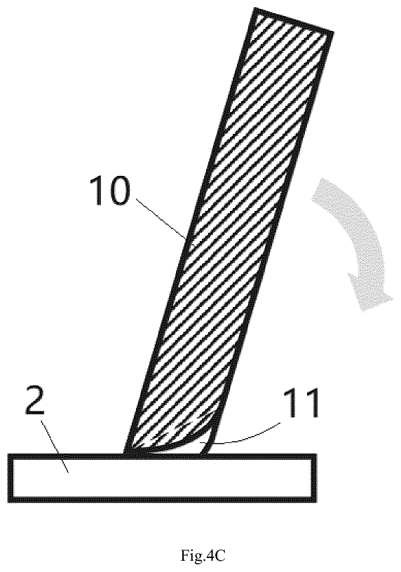

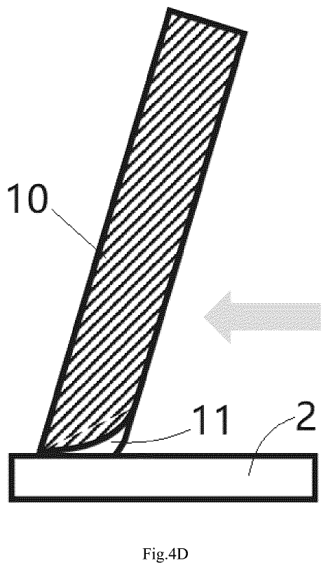

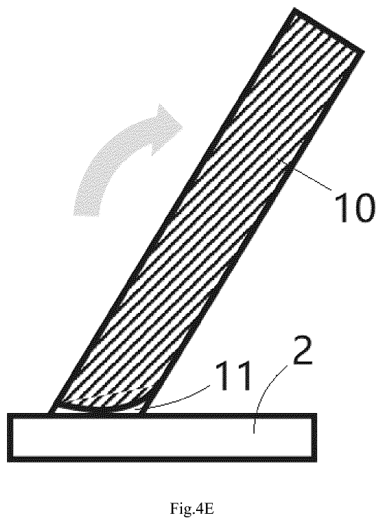

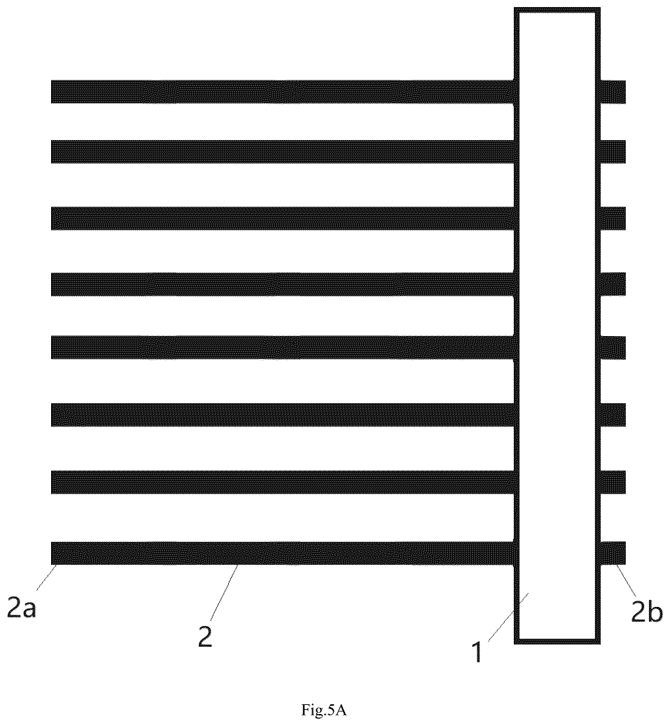

FIG. 4A shows an illustrative view of aligning the positioning slot 11 on the hot press welding head 1 with the wire 2. FIG. 4B shows an illustrative view of positioning wire 2 in the front part 11c of the positioning slot 11 of the hot press welding head 1 by vertically moving the hot press welding head 1. FIG. 4C shows an illustrative view of positioning wire 2 in the front part 11c and middle part 11e of the positioning slot 11 of the hot press welding head 1 by rotating the hot press welding head 1. FIG. 4D shows an illustrative view of moving the hot press welding head 1 horizontally to the end 2a of wire 2 to be welded. FIG. 4E shows an illustrative view of positioning wire 2 in the front part 11c, middle part 11e, and rear part 11d of the positioning slot 11 of the hot press welding head 1 by rotating the hot press welding head 1.

As shown in FIGS. 1-4 and 6, when welding the wire 2, the front side surface 10a and rear side surface 10b of the main body 10 of the hot press welding head 1 are inclined at a predetermined angle relative to the axial direction of wire 2 such that the wire 2 is positioned in the entire positioning slot 11. The positioning slot 11 has a V-shaped cross-section, allowing it to be used to position wires 2 with different diameters. The positioning slot 11 has a pair of inclined inner side surfaces 11a and an inner bottom surface 11b located between the bottom edges of the pair of inclined inner side surfaces 11a. The pair of inclined inner side surfaces 11a of the positioning slot 11 are used to rest against the wire 2 and position the wire 2 in positioning slot 11.

The pair of inclined inner side surfaces 11a of the positioning slot 11 are symmetrically arranged at both sides of the inner bottom surface 11b of the positioning slot 11. The inclined inner side surface 11a of the positioning slot 11 is inclined at a predetermined angle β relative to the cross-section of the main body 10. In the illustrated embodiment, the predetermined angle β is greater than 0 degrees but less than 30 degrees; or the predetermined angle β is greater than 5 degrees but less than 25 degrees; or the predetermined angle β is greater than 10 degrees but less than 20 degrees. However, the present invention is not limited to the illustrated embodiments, for example, the above predetermined angle β can be reasonably set according to operating parameters.

The positioning slot 11 has an opening located on the curved bottom surface 10c of the main body 10. The width of the opening of the positioning slot 11 gradually decreases from the front side surface 10a of the main body 10 towards the rear side surface 10b of the main body 10. In the illustrated embodiments, the inner bottom surface 11b of the positioning slot 11 is arc-shaped, and the inner bottom surface 11b of the positioning slot 11 has a constant width.

The hot press welding head 1 further comprises a pair of connection ends 12, which are respectively connected to the longitudinal ends of the main body 10 for electrical connection to two electrode ends of a power supply (not shown). In the illustrated embodiments, a connection hole 12a is formed in the connection end 12, so that the connection end 12 can be fastened to the electrode end of the power supply through a connection member (for example, a bolt or a screw) passing through the connection hole 12a.

As shown in FIGS. 1-4 and 6, in another exemplary embodiment of the present invention, a wire welding device is also disclosed. The wire welding device includes the aforementioned hot press welding head 1 and a moving device. The moving device is used to move the hot press welding head 1 to position a row of wires 2 in the row of positioning slots 11 of the hot press welding head 1. In an exemplary embodiment of the present invention, the moving device may be a multi degree of freedom robot or robotic arm, and the hot press welding head 1 is installed at the end of the multi degree of freedom robot or robotic arm.

In another exemplary embodiment of the present invention, a wire welding method is also disclosed. The wire welding method includes the following steps of:
S10: providing the aforementioned hot press welding head 1 or the aforementioned wire welding device;
S20: moving the hot press welding head 1 so that the row of positioning slots 11 on the hot press welding head 1 are aligned with the row of wires 2 to be welded; and
S30: moving the hot press welding head 1 so that the row of wires 2 are positioned in the row of positioning slots 11 of the hot press welding head 1.

The aforementioned step S20 includes:
S21: moving the hot press welding head 1 above the row of wires 2 and making the curved bottom surface 10c of the hot press welding head 1 face downwards;
S22: adjusting the hot press welding head 1 to the predetermined orientation, so that the front side surface 10a of the main body 10 of the hot press welding head 1 faces towards the ends 2a to be welded of the row of wires 2 and is perpendicular to the axial direction of a row of wires 2; and
S23: moving the hot press welding head 1 to its initial position, so that the hot press welding head 1 is positioned at a predetermined distance from the ends 2a to be welded of the row of wires 2 in the axial direction of the row of wires 2, and the row of positioning slots 11 on the hot press welding head 1 is aligned with the row of wires 2. The positioning slot 11 has a front part 11c near the front side surface 11a of the main body 10, a rear part 11d near the rear side surface 11b of the main body 10, and a middle part 11e located between the front part 11c and the rear part 11d.

The aforementioned step 30 includes:
S31: As shown in FIGS. 4A and 4B, moving the hot press welding head 1 vertically towards the row of wires 2 until the row of wires 2 is positioned in the front parts 11c of the row of positioning slots 11; Due to the large opening in the front part 11c of positioning slot 11, it is easy to guide and position the wire 2 into the front part 11c of positioning slot 11, thereby reducing the difficulty of positioning;
S32: rotating the hot press welding head 1 backwards and downwards with the row of wires 2 as the fulcrum, so that the row of wires 2 is positioned in the front parts 11c and middle parts 11e of the row of positioning slots 11;
S33: moving the hot press welding head 1 forward horizontally until it is adjacent to the ends 2a to be welded of the row of wires 2; In this way, the row of wires 2 can be straightened to improve welding accuracy; and
S34: rotating the hot press welding head 1 backwards and downwards with the row of wires 2 as the fulcrum, so that the row of wires 2 is positioned in the front parts 11c, middle parts 11e, and rear parts 11d of the row of positioning slots 11, thereby positioning the wire 2 in the entire positioning slot 11.

In step S32, the hot press welding head 1 is rotated from a vertical position perpendicular to the axial direction of the row of wires 2 to a first inclined position inclined to the axial direction of the row of wires 2. In step S33, the hot press welding head 1 is rotated from the first inclined position to a second inclined position inclined to the axial direction of the row of wires 2.

When the hot press welding head 1 is rotated to the first inclined position, the front side surface 10a and rear side surface 10b of the main body 10 of the hot press welding head 1 are inclined to a first angle relative to the axial direction of the row of wires 2. When the hot press welding head 1 is rotated to the second inclined position, the front side surface 10a and rear side surface 10b of the main body 10 of the hot press welding head 1 are inclined to a second angle relative to the axial direction of a row of wires 2. In the exemplary embodiment, the second angle is smaller than, or less than, the first angle.

In one embodiment, the first angle is greater than 60 degrees but less than 90 degrees, and the second angle is greater than 40 degrees but less than 60 degrees. In another embodiment, the first angle is greater than 70 degrees but less than 90 degrees, and the second angle is greater than 50 degrees but less than 70 degrees. In another embodiment, the first angle is greater than 80 degrees but less than 90 degrees, and the second angle is greater than 60 degrees but less than 80 degrees.

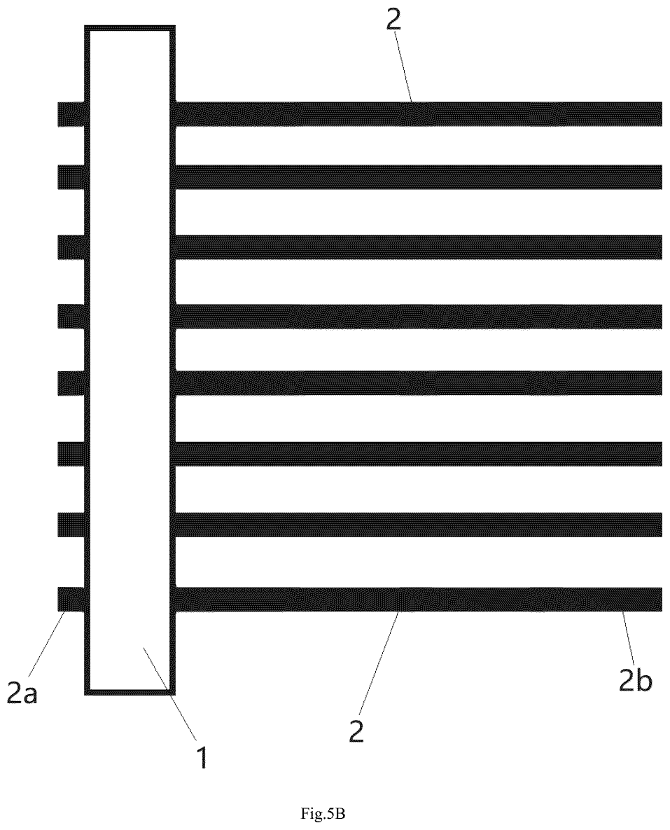

FIG. 5A shows an illustrative view of a row of wires 2 positioned in the row of positioning slots 11 of the hot press welding head 1, wherein the hot press welding head 1 is located at its initial position near the fixed ends 2b of the row of wires 2. FIG. 5B shows an illustrative view of the hot press welding head 1 being horizontally moved to the ends 2a of a row of wires 2 to be welded.

As shown in FIGS. 1 to 6, in the illustrated embodiments, the row of wires 2 has fixed ends 2b axially opposite to the ends 2a to be welded. In step S23, when the hot press welding head 1 is moved to its initial position, the hot press welding head 1 is close to the fixed ends 2b of the row of wires 2. In step S33, the hot press welding head 1 is moved from the fixed ends 2b of the row of wires 2 to the ends 2a to be welded.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A hot press welding head, comprising:
a main body, including:
a front side surface and a rear side surface opposite to each other in its transverse direction;
a curved bottom surface between bottom edges of the front side surface and the rear side surface, the bottom edge of the front side surface is lower than the bottom edge of the rear side surface in a height direction of the main body; and
a plurality of positioning slots formed on the curved bottom surface and arranged in a row along a longitudinal direction of the main body for simultaneously positioning multiple welded wires, the positioning slots extending along the transverse direction of the main body between the front side surface and the rear side surface.

2. The hot press welding head according to claim 1, wherein the main body is adapted such that, when welding the wires, the front side surface and rear side surface of the main body of the hot press welding head are inclined at a predetermined angle relative to the axial direction of the wire, and the wires are positioned in the entire respective positioning slot.

3. The hot press welding head according to claim 1, wherein each of the positioning slots has a V-shaped cross-section.

4. The hot press welding head according to claim 3, wherein each of the positioning slots has a pair of inclined inner side surfaces and an inner bottom surface located between the bottom edges of the pair of inclined inner side surfaces, the pair of inclined inner side surfaces of each of the positioning slots are adapted to rest against the wire to position the wire in the positioning slot.

5. The hot press welding head according to claim 4, wherein the pair of inclined inner side surfaces of each of the positioning slots are symmetrically arranged at both sides of the inner bottom surface of the positioning slot.

6. The hot press welding head according to claim 5, wherein the inclined inner side surface of each of the positioning slots is inclined at a predetermined angle relative to the cross-section of the main body.

7. The hot press welding head according to claim 6, wherein:
the predetermined angle is greater than 0 degrees but less than 30 degrees; or
the predetermined angle is greater than 5 degrees but less than 25 degrees; or
the predetermined angle is greater than 10 degrees but less than 20 degrees.

8. The hot press welding head according to claim 4, wherein each of the positioning slots has an opening located on the curved bottom surface of the main body, and the width of the opening of the positioning slot gradually decreases from the front side surface of the main body towards the rear side surface of the main body.

9. The hot press welding head according to claim 8, wherein the inner bottom surface of each of the positioning slots is arc-shaped, and the inner bottom surface of the each of the positioning slots has a constant width.

10. The hot press welding head according to claim 1, further comprising a pair of connection ends which are respectively connected to the longitudinal ends of the main body for electrically connecting to two electrode ends of a power supply.

11. The hot press welding head according to claim 10, wherein a connection hole is formed in the connection end and adapted such that the connection end can be fastened to the electrode end of the power supply through a connection member passing through the connection hole.

12. A wire welding device, comprising:
a hot press welding head, including:
a main body, having:
a front side surface and a rear side surface opposite to each other in its transverse direction;
a curved bottom surface between bottom edges of the front side surface and the rear side surface, the bottom edge of the front side surface is lower than the bottom edge of the rear side surface in a height direction of the main body; and
a plurality of positioning slots formed on the curved bottom surface, and arranged in a row along a longitudinal direction of the main body for simultaneously positioning multiple welded wires, the positioning slots extending along the transverse direction of the main body between the front side surface and the rear side surface; and
a moving device adapted to move the hot press welding head to position a row of wires into the row of positioning slots of the hot press welding head.

13. The wire welding device according to claim 12, wherein the moving device is a multi-degree of freedom robot or robotic arm, and the hot press welding head is installed at an end of the multi-degree of freedom robot or robotic arm.

14. A wire welding method, comprising following steps of:
S10: providing the hot press welding head, comprising:
a main body, including:
a front side surface and a rear side surface opposite to each other in its transverse direction;
a curved bottom surface between bottom edges of the front side surface and the rear side surface, the bottom edge of the front side surface is lower than the bottom edge of the rear side surface in a height direction of the main body; and
a plurality of positioning slots formed on the curved bottom surface, and arranged in a row along a longitudinal direction of the main body for simultaneously positioning multiple welded wires, the positioning slots extending along the transverse direction of the main body between the front side surface and the rear side surface;
S20: moving the hot press welding head so that the row of positioning slots on the hot press welding head are aligned with a row of wires to be welded; and
S30: moving the hot press welding head so that the row of wires is positioned in the row of positioning slots of the hot press welding head.

15. The wire welding method according to claim 14, wherein the step S20 comprises the further steps of:
S21: moving the hot press welding head above the row of wires and making the curved bottom surface of the hot press welding head face downwards;
S22: adjusting the hot press welding head to a predetermined orientation, so that the front side surface of the main body of the hot press welding head faces the ends to be welded of the row of wires and is perpendicular to the axial direction of the row of wires; and
S23: moving the hot press welding head to its initial position, so that the hot press welding head is positioned at a predetermined distance from the ends to be soldered of the row of wires in the axial direction of the row of wires, and the row of positioning slots on the hot press welding head is aligned with the row of wires.

16. The wire welding method according to claim 15, wherein:
each of the positioning slots has a front part near the front side surface of the main body, a rear part near the rear side surface of the main body, and a middle part located between the front part and the rear part; and
the step S30 comprises the further steps of:
S31: moving the hot press welding head vertically towards the row of wires until the row of wires is positioned in the front parts of the row of positioning slots;
S32: rotating the hot press welding head backwards and downwards with the row of wires as the fulcrum, so that the row of wires is positioned in the front parts and middle parts of the row of positioning slots;
S33: moving the hot press welding head forward in a horizontal direction until it is adjacent to the ends to be welded of the row of wires; and
S34: rotating the hot press welding head backwards and downwards with the row of wires as the fulcrum, so that the row of wires is positioned in the front parts, middle parts, and rear parts of the row of positioning slots.

17. The wire welding method according to claim 16, wherein:
in the step S32, the hot press welding head is rotated from a vertical position perpendicular to the axial direction of the row of wires to a first inclined position inclined to the axial direction of the row of wires; and
in the step S33, the hot press welding head is rotated from the first inclined position to a second inclined position inclined to the axial direction of the row of wires.

18. The wire welding method according to claim 17, wherein:
when the hot press welding head is rotated to the first inclined position, the front side surface and rear side surface of the main body of the hot press welding head are inclined to a first angle relative to the axial direction of the row of wires; and
when the hot press welding head is rotated to the second inclined position, the front side surface and rear side surface of the main body of the hot press welding head are inclined to a second angle relative to the axial direction of the row of wires, and the second angle is smaller than the first angle.

19. The wire welding method according to claim 18, wherein:
the first angle is greater than 60 degrees but less than 90 degrees, and the second angle is greater than 40 degrees but less than 60 degrees; or
the first angle is greater than 70 degrees but less than 90 degrees, and the second angle is greater than 50 degrees but less than 70 degrees; or
the first angle is greater than 80 degrees but less than 90 degrees, and the second angle is greater than 60 degrees but less than 80 degrees.

20. The wire welding method according to claim 16, wherein:
the row of wires has fixed ends axially opposite to the ends to be welded of the row of wires;
in the step S23, when the hot press welding head is moved to its initial position, the hot press welding head is close to the fixed ends of the row of wires; and
in the step S33, the hot press welding head is moved from the fixed ends of the row of wires to the ends to be welded of the row of wires.
